(19) United States
(12) Patent Application Publication
(10) Pub. No.: US 2006/0146122 A1
(43) Pub. Date: Jul. 6, 2006

(54) System for remotely capturing and storing images for multiple users in a centralized image management center

(76) Inventors: Chad McDonald, Hudson, WI (US); Nathan Edin, Hudson, WI (US); Lon Feia, Hudson, WI (US)

Correspondence Address: KEVIN HUBBARD;Kagan Binder PLLC, Maple Island Building, Ste. 200, 221 Main Street North, Stillwater, MN, 55082, US

(21) Appl. No.: 11/257,827

(22) Filed: Oct. 24, 2005

Related U.S. Application Data
(60) Provisional application No. 60/621,962, filed on Oct. 25, 2004.

(51) Int. Cl. H04N 7/14

(52) U.S. Cl. 348/14.03

(57) ABSTRACT

The present invention provides a system for remotely capturing and storing images for multiple users in a centralized image management center. Users respectively set up one or more image capture devices in one or more desired remote locations. The devices have the capability not only to automatically capture images, but also to automatically forward those images along with other associated data to the centralized image management center. Image data may be photo data, video data, and/or the like.

### REFERENCE TO RELATED APPLICATIONS

This application claims the benefit of U.S. Provisional Application having Ser. No. 60/621,962, filed on Oct. 25, 2004, entitled “System for Remotely Capturing and Storing Images for Multiple Users in a Centralized Image Management Center,” the entire disclosure of which is incorporated herein by reference for all purposes.

### TECHNICAL FIELD

The present invention relates to remote visual monitoring systems and methods and, more particularly, relates to cameras and communications network systems and methods providing for remote access of visual information over the network.

### BACKGROUND

Visual monitoring for security and other reasons is presently employed and generally known. In conventional visual monitoring systems, a camera is directed at an area to be viewed. The camera provides a signal to a monitor located at a remote geographic location to the camera.

Wireless digital communications are commonly used in such monitoring applications. For example, wireless digital cellular networks are commonly employed. Typical cellular systems support voice calls and data communications. Various protocols and packeted information formats can be used in cellular communications to achieve various results. Moreover, new protocols, compression techniques, and communications equipment are continually being developed.

Wide area networks, including, for example, the Internet, are widely known and accessible. Communications over such networks take a variety of forms. In the case of the Internet, individual consumers, as well as large business, employ the giant network for communications. Those communications include information, voice, images, live video, all of which are typically communicated in the form of digital data. Wireless communications with the Internet and other networks is possible at high speeds and these and other communication methods continue to be evolving.

Although many aspects of such communication networks, digital cellular communications, and remote visual monitoring systems are conventional, those aspects have not provided satisfactory transmission and access of that information via wireless and network access. Limitations on the prior art that have prevented network access viewing of remotely monitored visual events include rates of wireless communications of visual information, accessibility to networks capable of providing such information, specialized equipment and software required for communicating such information, and complexity, expense, and capabilities of available cameras, networks, and related systems and operations.

### SUMMARY

The present invention provides a system for remotely capturing and storing images for multiple users in a centralized image management center. Users respectively set up one or more image capture devices in desired remote location(s). The devices have the capability not only to automatically capture images, but also to automatically forward those images along with other associated data to the centralized image management center. Image data may be photo data, video data, and/or the like.

The remote image acquisition devices may be set up to automatically capture images upon the occurrence of one or more triggering events. One example of a triggering event is motion detection. Image data is then transferred to a centralized image management center where the image data is stored for viewing by one or more authorized users. Users interact through the system through one or more suitable interfaces, such as the internet.

A preferred embodiment of the invention constitutes a “turnkey” digital photo/video album for multiple users with automated image capture and subsequent centralized storage. Any user can acquire one or more image capture devices, set the devices up to capture remote images and the system provides the centralized resources to create, edit, service, maintain, and otherwise manage photo/video/audio collections.

The system has many useful applications. As one example, devices may be set up to monitor the security of buildings, construction sites, parks, other public places, and the like. Even when security is not an issue, the system may be used to monitor desired subject matter, such as animals, including domestic animals and wild game. For instance, it is common for hunters to set up remote automated cameras to monitor game trails, watering areas, and the like. Conventionally, the hunter places the camera in the desired monitoring location and then must return to the camera to determine if any images have been captured. Because game cameras may be positioned in remote locations, checking game cameras can involve a significant investment of time and effort. The present invention greatly simplifies this. Initially, a remote, automated camera can be set up. Thereafter, image management can occur from any location (home, work, etc.) by accessing the central image management center via a suitable interface (e.g., the internet). The devices and system of the present invention also can be set up to monitor the movement of people entering and leaving areas, e.g., malls, airports, sport facilities, etc.

### BRIEF DESCRIPTION OF THE DRAWINGS

The present invention will be further explained with reference to the appended Figures, wherein like structure is referred to by like numerals throughout the several views, and wherein:

FIG. 1 is a schematic view of an image management system of the present invention;

FIG. 2 is a schematic view of a remote image acquisition device of the present invention;

FIG. 3 shows representative device data fields that may constitute at least a portion of a device data group in accordance with the present invention;

FIG. 4 shows representative image data fields that may constitute at least a portion of an image data group in accordance with the present invention;

FIG. 5 is a front view of an image acquisition device in accordance with the present invention;

FIG. 6 shows the image acquisition device of FIG. 5 with an access door in an open position;

FIG. 7 is a rear view of the image acquisition device of FIG. 5;

FIG. 8 is a schematic view of a centralized image management system in accordance with the present invention;

FIG. 9 illustrates a client information database in accordance with the present invention;

FIG. 10 shows a mode of an image capture event by which a representative, remote image acquisition device captures one or more images and then transmits the image(s) to a centralized image management center in accordance with the present invention;

FIG. 11 schematically shows a flow chart of one way in which a system of the present invention can capture an image and allow a user to view the image; and

FIG. 12 shows a manner of using a system of the invention to remotely capture and view images of wild game.

### DETAILED DESCRIPTION

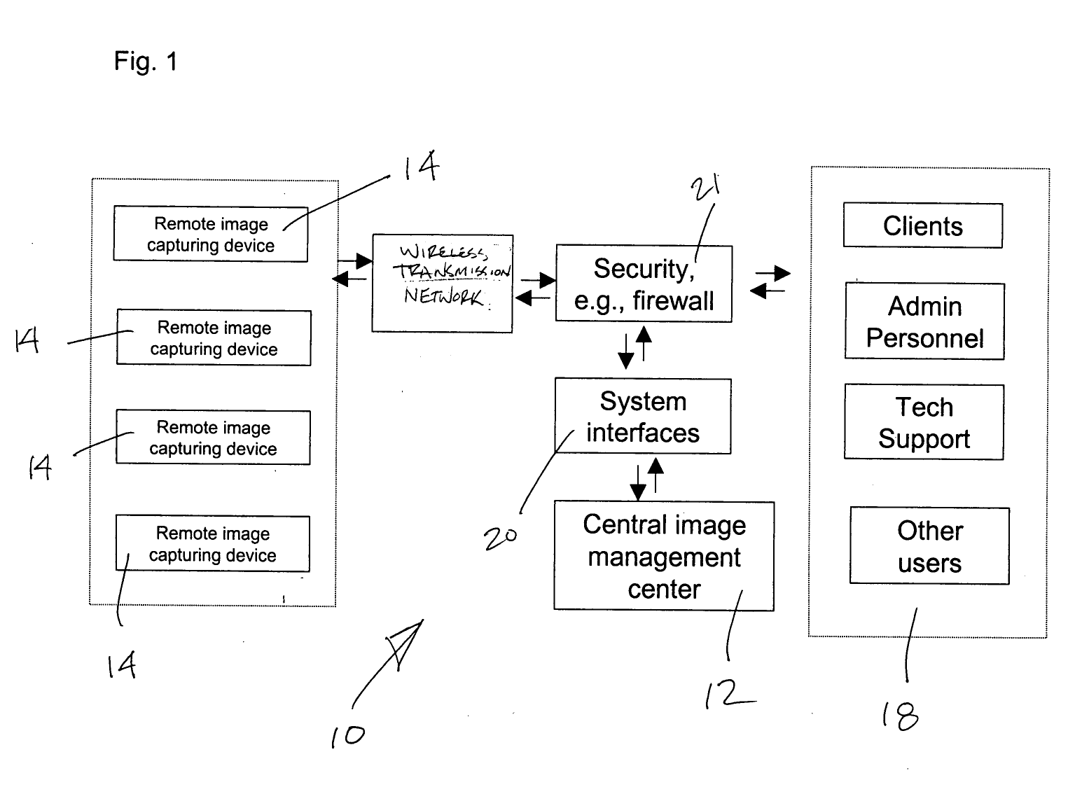

FIG. 1 schematically illustrates a preferred embodiment of an image management system 10 of the present invention. Images are stored, viewed, managed, and otherwise handled in a centralized image management center 12. The images are acquired from a plurality of remote image acquisition devices 14. Authorized users, e.g., clients, respectively set up one or more of these devices in desired remote locations. The image data is acquired or converted to a format suitable for the desired mode of wireless transmission from the devices to the centralized image management center 12. Once in the proper format, processed as desired, and organized as desired, the data associated with an image is then transmitted to the centralized image management center 12 using a suitable wireless transmission network 16. Any suitable type of wireless transmission may be used. Widely available, commercially available methods include cellular networks, satellite networks, and microwave networks. Cellular networks are preferred as these are secure and provide high transmission capability well-suited to image data transfer. The centralized image management center 12 receives, stores, and makes the images available to authorized users in an appropriately controlled fashion.

Communications between the centralized image management center 12 and the remote image acquisition devices 14 generally are two-way via a pathway that includes wireless transmission. Thus, in one direction, image information can be sent from the acquisition devices 14 to the centralized image management center 12. In the other direction, authorized, remote users 18 can monitor, check, and otherwise control the devices 14. The ability of a remote user 18 to monitor, check, or otherwise control the remote devices 14 will depend upon factors including the nature of the remote user 18. For instance, an authorized client may be allowed one level of access to control certain aspects by which the remote image acquisition device 14 acquires, processes and transmits image information. System administrators, account administrators, and/or technical support personnel, may be allowed a different level of access to perform these and other appropriate functions.

Clients, technical support, center administrative personnel interact with the centralized image management center 12 and each other through one or more interfaces 20. Suitable security 21 preferably is provided to help protect the integrity of the system. The clients, technical support, and/or center administrative personnel may interact with the centralized image management center 12 and with each other remotely through these interfaces 20.

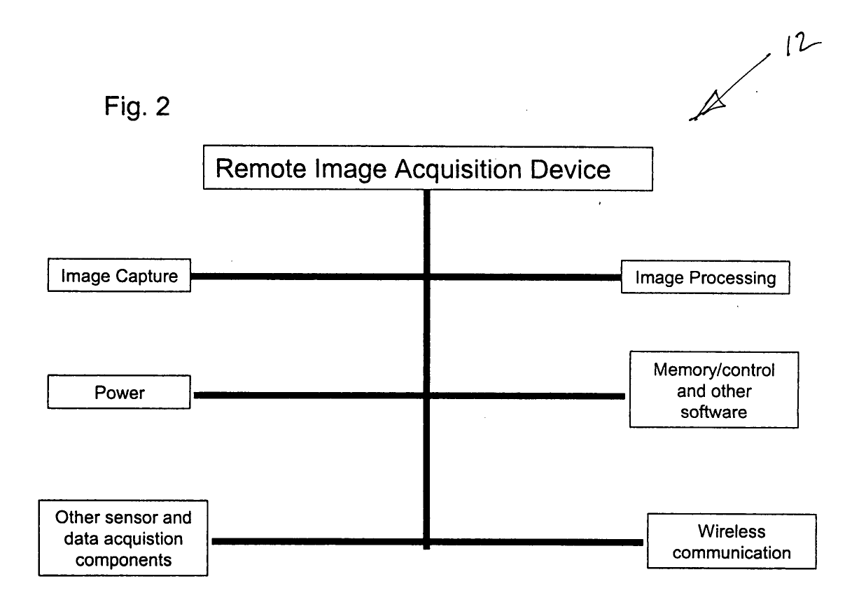

A representative embodiment of preferred, remote image acquisition device 14 of the present invention is shown schematically in FIG. 2. The device 14 generally includes hardware and software components to provide the functions and capabilities as shown, although some aspects of these functions and capabilities may be remotely provided by the centralized image management center 12 as desired. Firstly, the device 14 includes hardware and software to acquire images and associated data at the remote location. These images may be acquired in any suitable fashion. Representative approaches include those used in common digital cameras, common digital motion video cameras, infrared digital cameras, infrared digital motion video cameras, and the like. Preferably, images are acquired or converted to a digital format to facilitate processing, storing, and wireless transmittal. Images may be captured either as individual photos, and/or in a video format. The device 14 may include features and/or more than one image capturing component to provide a larger field of view. For example, the device 14 may include imaging capability that provides a 360-degree view of the area around the device 14.

Image capture may be manual or automated. Thus, the device 14 may be instructed, either locally or remotely, to capture one or more images on demand. Alternatively, the device 14 may be programmed to automatically capture images in a variety of ways. According to one approach, the device 14 may be programmed to capture images continually or at pre-defined time intervals. The device 14 also may be programmed to capture images upon the occurrence(s) of one or more triggering events. Triggering events include, for instance, the occurrence of a particular time or time interval, detection of an ambient temperature or change in temperature, detection of motion in proximity to the device 14, detection of movement of the device 14 itself, physical contact with the device 14, detection of sound, detection of a certain level or change in relative humidity, combinations of these, and the like. In preferred embodiments, the device 14 incorporates motion detection capability and is triggered to acquire image(s) upon detection of motion. Motion in the proximity of the device 14 may be detected in a variety of ways including via infrared (active or passive), ultrasonically, light beam, physical contact, physical barrier, and the like.

The image capture aspects of the device 14 preferably further include day/night sensors, light source control, image capture interval control and the like that are coordinated with image acquisition activities. Illumination sources may be in any suitable form such as flash, flood, LED, IR, strobe, combinations of these, and the like. Componentry also facilitates automated reset of the illumination source so that, after illuminating the target area, the light source is caused to reset/re-charge to be ready for the next image capture event.

A timer may be useful to control a minimum time interval between image capture events. This may be set by the user, for instance, to wait a pre-determined amount of time between image capture events or to limit the number of image captures in an interval. This is helpful in automated, remote image capture scenarios so that the device does not capture too many images of the same event depending upon what is desired by the user. Thus, if a trigger occurs within such a pre-set time interval, no image capture takes place.

The image processing aspects of the device 14 may further include hardware and software to process the images in a desired manner prior to transmittal from the device 14 to the centralized image management center 12. For instance, images may be converted to digital if acquired in analog or other fashion. Images may be compressed to a format that is more appropriate for transmission. IBLNT, JPEG and MPEG formats are currently popular compression formats. Images may also be processed in a way that modifies or enhances images, e.g., exposure correction, tone adjustment, bright adjustment, color enhancement, image sharpen, contrast, and the like In addition to image capture hardware and software, the device 14 may further include or have access to other hardware and/or software that allows the device 14 to detect or otherwise monitor and gather other data to be associated with the device 14 and/or an image. Examples include GPS position information, time and date data, weather information, light level information, device status and setting information, activity log data, service monitor to detect the signal strength for carrying out cellular communications, time information, security data, smoke/heat data, and the like. Signal strength monitoring may be desirable, for instance, to allow the device 14 to transmit data only when the signal strength is above a certain threshold. Unless and until appropriate signal strength is available, the device 14 may store gathered data. After data transmission, the device 14 may store or erase the transmitted data in accordance with desired programming and/or available device memory resources.

The device 14 further includes aspects for wireless transmission and receipt of data, such as communications to and from the central image management center 12. These aspects preferably include digital, e.g., cellular, data transmission and receiving components and an antenna. Digital, cellular networks offer secure, high transmission capabilities.

The device 14 further includes power supply components. These may include an internal power supply and/or components that allow the device to interact with an external power supply. For instance, power may be supplied by one or more internal and/or external batteries, a power cord that connect to an electric power supply, solar recharging panels, and the like.

The device 14 further includes memory allowing the device to store its programming and data. At least a portion of the device memory is preferably re-programmable to allow its memory capacity to be re-used throughout the useful life of the device.

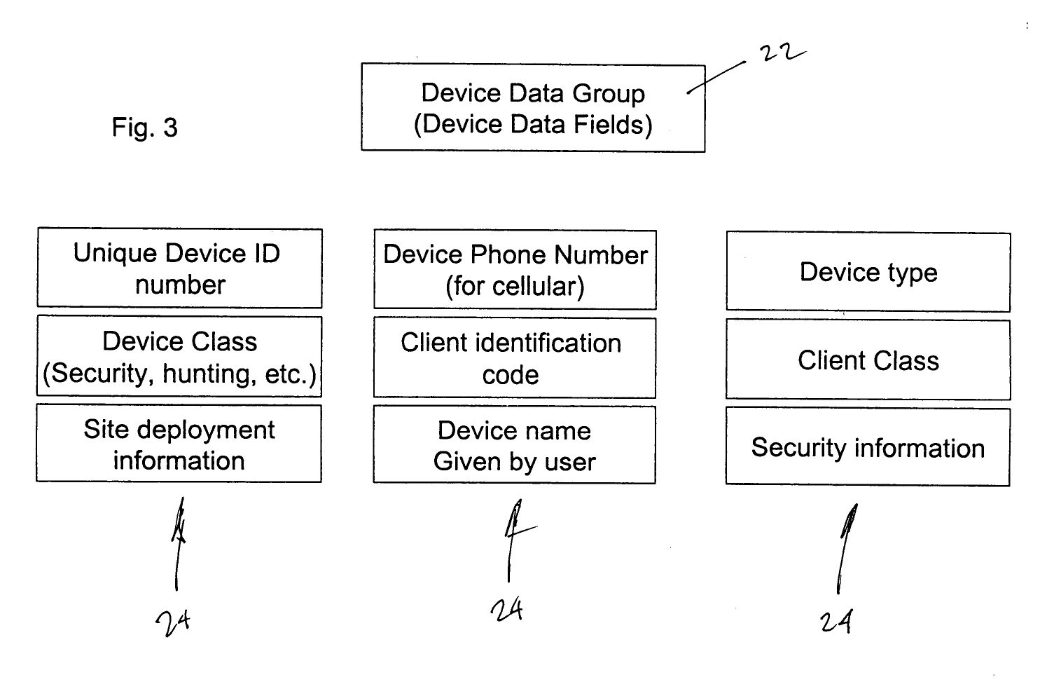

Referring to FIG. 3, the device 14 further includes a database including a device data group 22 in which data about the device 14 may be stored in a plurality of data fields 24. Depending upon memory requirements, the device data of the device data group 22 may be wholly or partly stored in the device 14 itself and/or in the central image management center 12. FIG. 3 shows representative device data fields 24 that may constitute at least a portion of the device data group 22. Some or all of the device data is stored within such fields in the centralized image management system 12 along with the corresponding data for a plurality of other devices. Some or all of the device data may also be stored in memory of the device as well. These fields facilitate activities by authorized, remote users to communicate with the device, as authorized, to check, customize, set, and otherwise control the device 14. The use of such fields to organize device information also facilitates oversight and corresponding image management for the device 14 in the central image management center 12.

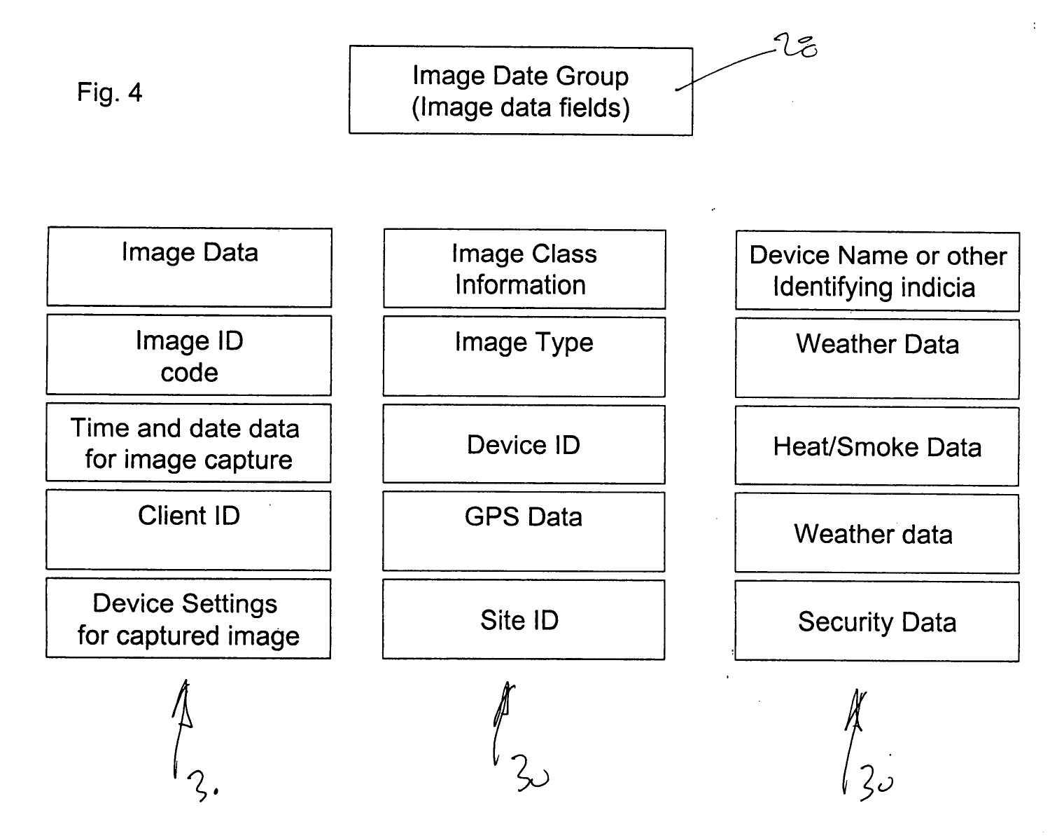

Referring to FIG. 4, the device 14 further includes a database including an image data group 20 in which data about the captured images may be stored in a plurality of image data fields 30. Depending upon memory requirements, the image data of the image data group 28 may be wholly or partly stored in the device itself and/or in the central image management center 12. FIG. 4 shows representative image data fields 30 that may constitute at least a portion of the image data group 28. Some or all of the image data is stored within such fields in the centralized image management system 12 along with the corresponding data for a plurality of other images for a plurality of images, users, and devices. Some or all of the image data may also be stored in memory of the device as well, at least temporarily until storage on the centralized image management system 12 is confirmed. Note how non-image information (e.g., GPS data, weather data, etc.) may be gathered and associated with a corresponding image. When image data is captured, processed, and then transmitted to the central image management center 12, other corresponding image data from the image data group 28 may be sent and associated with the image. The use of such fields to organize image information facilitates storing, retrieving, modifying, and otherwise managing the images in the central image management center 12.

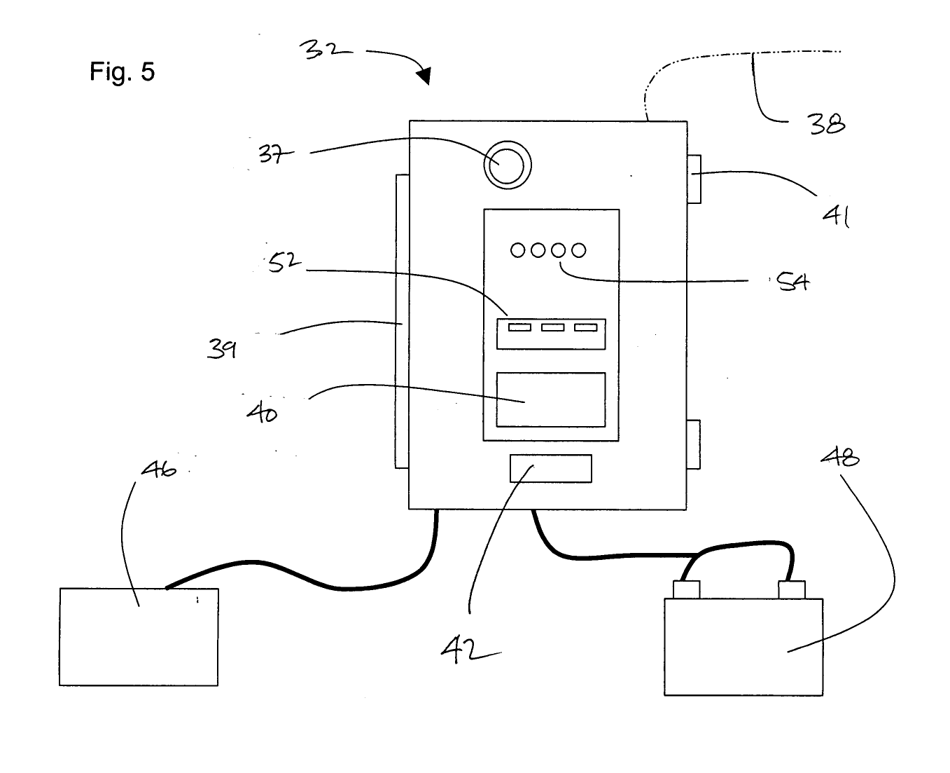

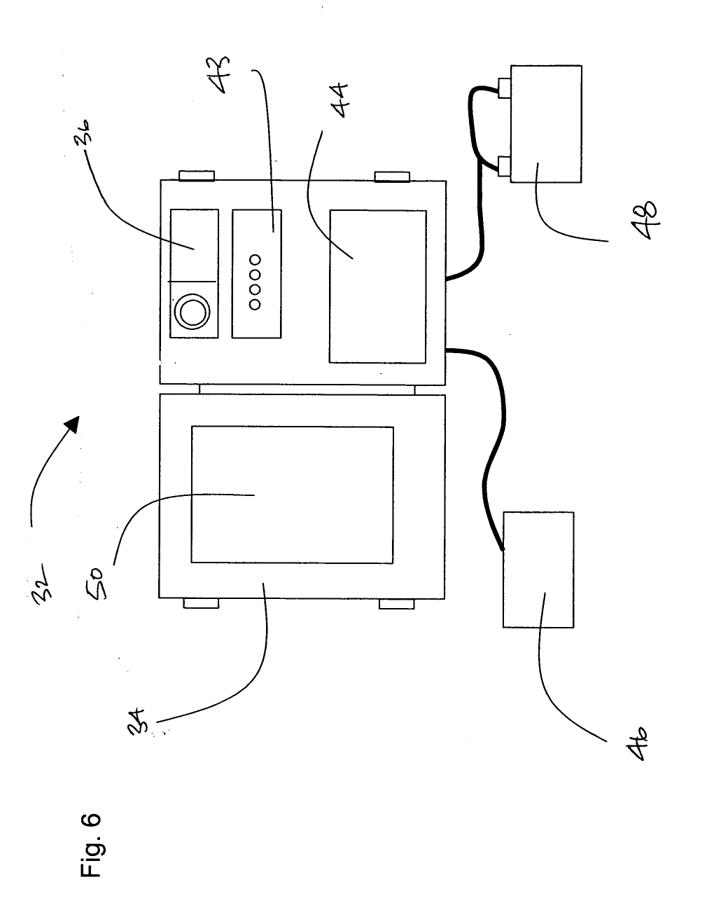

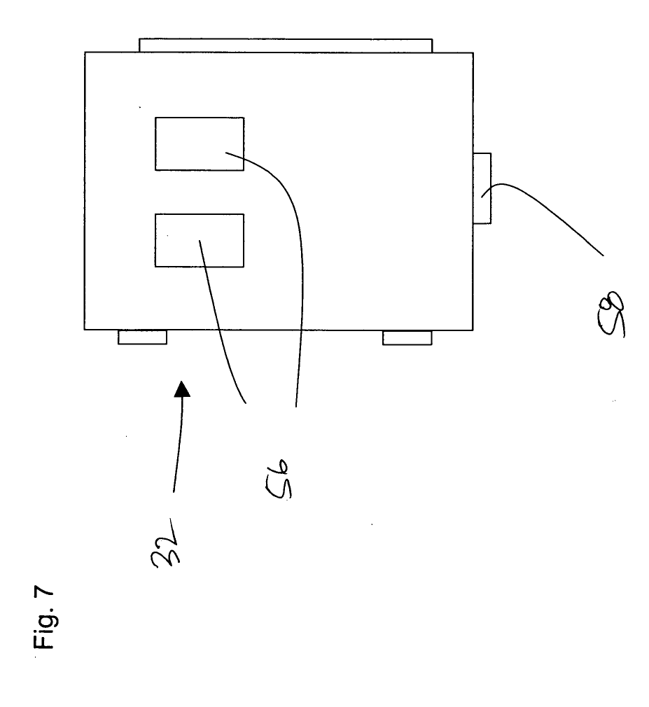

A representative embodiment of a preferred image acquisition device 32 of the present invention is shown in FIGS. 5 through 7. FIG. 5 shows a front view of the device 32 with access door 34 closed by hinge 39 and latch 41. FIG. 6 shows the device 32 with the access door 34 open. When the door 34 is closed, the device 32 is weatherproof, allowing the device 32 to be placed outdoors if desired. The device 32 includes an uplink digital camera unit 36 having lens 37 for acquiring image data and for transmitting and receiving cellular communications. As an alternative, these components may be incorporated into separate devices. For instance, a camera may communicate with a separate sending device that are not necessarily integrated into a single unit. An antenna 38 facilitates cellular communications. A 12 volt light source 40, for instance, provides an illumination source for low lighting conditions. An infrared motion detector 42 allows the unit to detect motion and thereby initiate an image capture event. An internal 12 volt battery 44 supplies power for device operations. Optional back up power components are shown and may be used singly or in combination. As one option, the battery may be coupled to a solar pad 46 for re-charging. As another option, the internal battery 44 may be coupled to an external battery 48. For purposes of illustration, the internal and external batteries are 12 volt units. The inside door panel may include desired text information 50, e.g., device operation and set up. Control componentry 43 provides hardware and software components for controlling device operation. One indicator 52 viewable on the external housing visually indicates the strength of the cellular communication signal. Another indicator 54 indicates the status of the battery charge. FIG. 7 shows the back side of the device 32. There, illustrative mounting hardware 56 is shown. As shown, belt holders are included for strapping the device 32 to a post, tree, or the like. A screw mounting bracket 58 is provided on the bottom of the unit as shown.

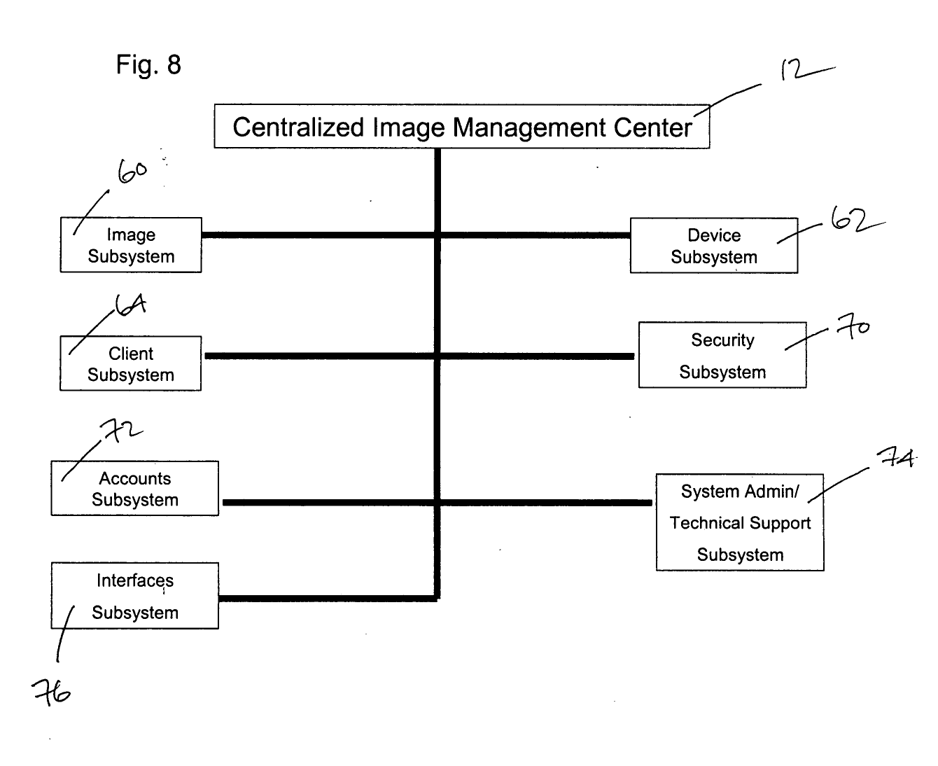

FIG. 8 schematically shows preferred components of the centralized image management system 12. These components include an image subsystem 60 that handles image intake, image data management, image viewing, image related notifications, etc. The image subsystem 60 comprises a database of image data stored in associated fields such as those shown in FIG. 3. This allows images to be easily stored, retrieved, viewed, and the like using image data stored in one or more of the image data fields 30. For instance, one can easily locate and view all images associated with a particular client, device, class, geographic location (via GPS information or the like), etc. One can easily locate a particular image associated with a particular image identification code or name. One can easily view all images for a particular user dealing with a particular subject. Due to storage limitations, the system may involve archiving and/or purging images after some time period. The protocols for archiving may depend upon factors such as image class, device class, and/or client class. For instance, one protocol may cause images of a particular class to be archived after they reach a predetermined age. The system preferably would include a way for clients to be able to retrieve these archived images according to desired criteria.

The image subsystem 60 preferably includes automated client notification capabilities. For instance, a client may be notified that they have a new image on the system. This notice may occur via e-mail and may include various kinds of content offering convenience to the client, such as a link to a web page that displays the image. The link may be indirect in the sense that the client first encounters a password page before being allowed access to the new image. The e-mail may also include an image thumbnail, depending upon client desires, image class, device class, system protocols, and/or the like. In addition to e-mail, notifications may occur via cellular phone, pager, satellite phone, etc. Preferences and/or protocols may be implemented such that these kinds of notices are sent after each new image is received, after a certain number of new images are received, at particular time intervals, or the like. In some modes, the notification function may be disabled, requiring the client to check the system periodically to see if new images have been acquired.

Another component of the centralized image management system 12 is the device subsystem 62 that handles management, control, instructing, setting up, and administration of remote image acquisition devices 14 associated with the centralized image management system 12. The device subsystem 62 includes a database of device data stored in associated fields such as those shown in FIG. 3. Thus, one can use field criteria to identify particular device(s) associated with a particular client, class, or the like in order to interact with, handle related information, or otherwise manage the desired device(s).

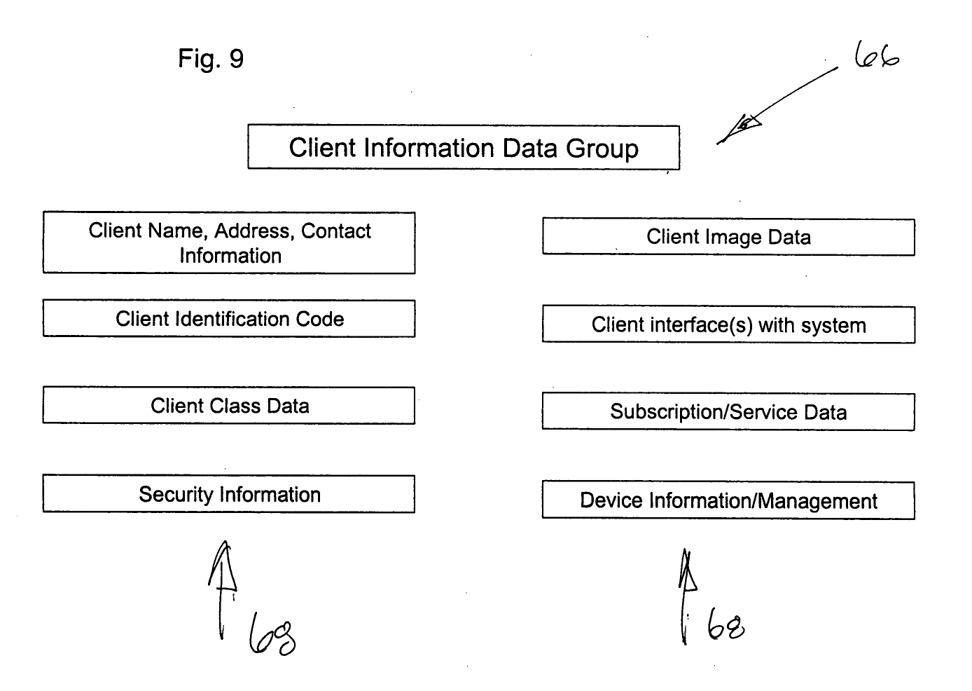

Another component of the centralized image management system 12 includes the client subsystem 64, which includes client-related information stored in corresponding fields in the database. A representative embodiment of a client information database 66 and its fields 68 is shown in FIG. 9.

As further shown in FIG. 8, the system further includes a security subsystem 70 that helps to guard access to and protect the system. For instance, centralized image management center 12 may be secured by using a “firewall” type of network security system. This will allow clients to have secure access to their image information, such as via one or more web pages, to do administrative, billing, and private viewing of their images captured by their device. It will allow the centralized image management center 12 to operate a secure internet interface that will protect customer's personal data, device data, and images stored on the site. Additional security protocols will control access to various system functions. For example, a client would only have access rights that allowed it to control its own devices or other authorized devices. Similarly, unless granted access by an appropriate entity to other images, a client would only have access to its own images. Further, some user options may only be available to certain classes of users and/or for certain classes of devices. For instance, clients using devices for security may have different user options available than clients that use devices for hunting. Another aspect of the security subsystem may involve an activity log that tracks and keeps records of desired activities.

The accounts subsystem 72 provides features and functions to help manage and handle accounting/billing for clients. For instance, the accounts subsystem 72 may record image data as received and debit the corresponding client account accordingly. Preferably, such billing, security, access, etc will be automated by the server and clients will be able to pay billings, activate cameras, direct access of their web page, and administrate their preferences. The account management service preferably will notify the client of any issues, misuses, unauthorized access, etc. The account management service will also shut off service to those whose access rights have expired or otherwise terminated. In those embodiments in which billing is automated, it is preferred that billing notices automatically be sent via E-mail, pager, regular mail, phone notification, auto debit in accordance with client desires and system protocols. Accounts payable may also be automated. For instance, payments may be made directly through the web site via CC, PayPal, Autodraft, etc. The account management function can notify Accounts Receivable if a client does not pay or is delinquent.

Each of the databases of the various subsystems preferably are linked, allowing data to be accessed, searched, retrieved, modified, authenticated, managed, and the like using field criteria from more than one database. Indeed, note how certain data fields, e.g., client ID, appear in more than one data group. For instance, if a client having multiple devices in multiple classes wants to view its night-time images captured by its devices of a particular class, this can be done based upon data in the device class field from the device database and the image time field from the image database.

Still referring to FIG. 8, the system also includes a system administration and technical support subsystem 74. System administration operates, administers, modifies, maintains, manages, fixes, provides technical support, handles accounts, and/or otherwise takes care of the system.

The system also includes an interface subsystem 76 that provides interfaces for users to access the system in a controlled fashion based upon the nature of the user. Different kinds of system users include clients and other authorized image viewers, potential clients, system administrators and operators, and technical support personnel. Clients, for instance, may be provided with phone, e-mail, and web page interfaces in order to interact with the system as well as system personnel such as technical support. In preferred modes, clients may interact with the system via the internet. The client preferably will have a security protected account allowing them to access to sort, view print, modify, save, download, name, delete etc. their images that are stored on the system.

Technical support and administrative personnel may be provided with an interface that allows them to interact with clients, devices, and the centralized image management system 12 in an appropriate fashion. For example, a technical support interface might allow technical support and administrative personnel to manage accounts, e.g., edit client data, set preferences, change billing/program information; to remotely access to image capture devices (e.g., for setting configurations, updating programs, testing, etc.); to manage web accounts (e.g., trouble shoot problems, configure, manage data storage issues, etc); to trouble shoot hardware problems (e.g., image capture device problems), analyze problems, and suggest solutions for clients; and authorize returns for service.

The website interfaces for users may be configured to have SSL “Secure Socket Layer”, SSH or other similar available technology in order to provide secure remote management of the web site for Administrators, Tech Support, and other internal needs. This will provide additional security. Additionally, the website TCP/IP port (HTTP or HTTPS or other) is one embodiment of a user interface for accessing all information in a secure manner. All users will be subject to security protocols that will allow them to view only authorized data. A user may set up its account, if desired, to allow others or the public to access its images in a controlled way, such as to view, print, save, the images as authorized by the client.

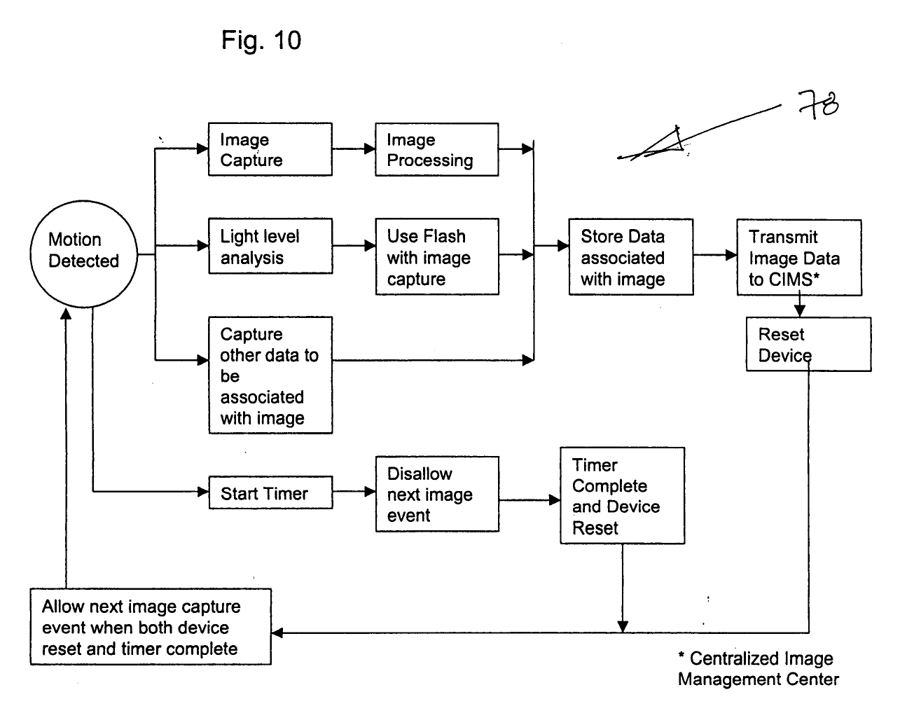

FIG. 10 schematically shows one representative mode of an image capture event 78 by which a representative, remote image acquisition device 14 captures one or more images and then transmits the image(s) to the centralized image management center 12. Initially, the device or componentry appropriately linked to the device 14 detects a triggering event. For purposes of illustration, the triggering event is the detection of motion in front of the image capture device 14. The triggering event causes the camera component of the device 14 to capture one or more images as desired. For instance, the camera may be caused to shoot one, two, or more pictures at pre-defined intervals. Alternatively, the camera may be caused to capture video for a predefined period of time.

So as to be coordinated with the image capture, lighting conditions are monitored so that, depending perhaps upon lighting conditions, an illumination source such as a flash may also be used to illuminate the field of view of the camera during image capture. After illuminating the target area, the light source is automatically caused to reset/re-charge to be ready for the next image capture.

Also coordinated with the occurrence of an image capture, a timer is started. The timer works to provide a measured minimum time interval between permissible image capture events. This time interval may be set by an authorized user to either allow the camera to capture images with no wait or to wait a predetermined amount of time before detection of a triggering event would cause another image capture event. When the timer is complete, the device is reset to allow image capture upon detection of the next triggering event.

Also coordinated with the occurrence of an image capture, the device 14 may also capture other data to be associated with the image capture. Examples of such other data are shown as image data fields on FIG. 3 and include weather data, time data, temperature data, GPS data, whether flash was used, lighting conditions, device status, etc.

The captured image data may then be processed by the device 14, e.g., conversion to digital if desired, data compression, filtering, or the like. The data associated with the image capture event, e.g., image data associated with one or more image data fields and optionally device data associated with one or more device data fields are transmitted to the central image management center 12. For purposes of illustration, this transmission occurs via long range wireless data transfer such as by cellular and/or satellite. When the data is received by the central image management center 12, the data is stored in association with the corresponding fields. Once stored, the data is accessible by the authorized user(s) according to access rights and privileges.

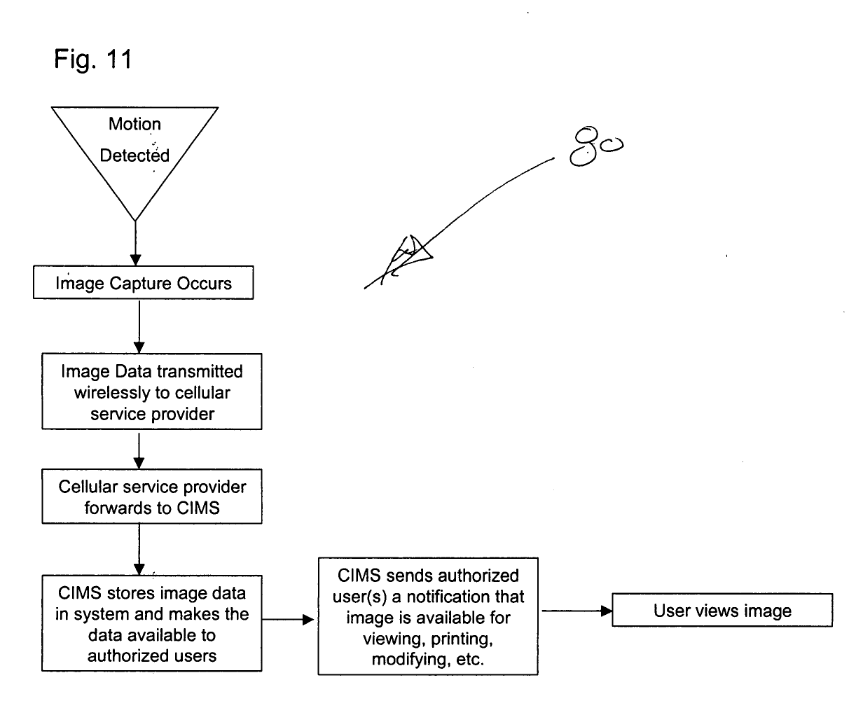

FIG. 11 schematically shows a flow chart 80 of one way in which the system of the present invention captures an image and allows a user to view it.

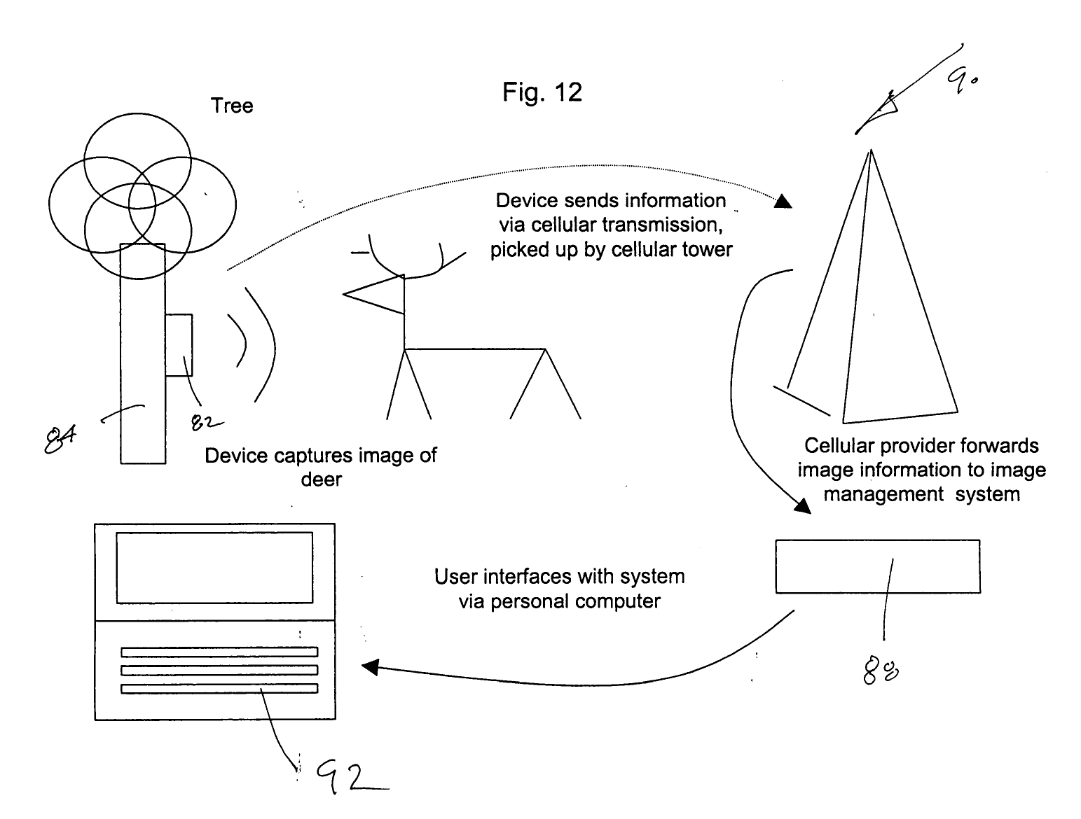

One particularly preferred mode of practice involves using the system of the present invention to remotely capture and view images of wild game. For instance, a hunter may wish to monitor animal traffic along a particular game trail or the like. FIG. 12 schematically shows this mode of practice. An image capture device 82 is mounted via a belt or the like to a tree 84 at the desired game monitoring site. For purposes of illustration, the device 82 is caused to capture one or more images of a deer 86 upon the detection of the deer's motion. Other data associated with one or more image data fields is also captured. The captured and acquired image data is then transmitted to the centralized image management center 88 using a wireless network 90 such as a cellular network. In a preferred mode of transmission, the cellular service receives the data wirelessly and then transmits the data to the centralized image management center 88 via e-mail inasmuch as large volumes of cellular communications can be sent and received this way. The desired image data, which may include data for both image and device data fields, is stored on the system and made available for viewing, sorting, printing, downloading, etc., to authorized users at a remote terminal 92. An e-mail notification is sent to the corresponding client that a new image has been received. The client connects to the system via an internet interface and views the captured image.

The complete disclosures of the following documents are incorporated by reference in their respective entireties:
EP 1317144 A1
U.S. Pat. No. 5,926,210
U.S. Pat. No. 6,035,323
U.S. Pat. No. 6,122,526
U.S. Pat. No. 6,166,729
U.S. Pat. No. 6,697,103
U.S. Pat. No. 6,697,104 B1
U.S. Pat. No. 6,704,040 B2
U.S. Patent Publication 2001/0010541 A1
U.S. Patent Publication 2003/0135865 A1
U.S. Patent Publication 2004/0001214 A1
U.S. Patent Publication 2004/0024876 A1
WO 02/19688 A2
WO 03/030552 A1
WO 98/51080
WO 99/35818

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

What is claimed is:

1. A system for storing digital images for multiple users, comprising
(i) a plurality of remote image capturing devices, wherein at least a portion of the devices are set up to automatically capture one or more images upon the occurrence of one or more triggering events;
(ii) a centralized database comprising a memory storing multiple user data, multiple image data, and multiple device data in associated data fields wherein image data stored in the database is linked to a remote image capturing device and a user;
(iii) a communication pathway along which images captured by the remote image capturing devices are transmitted from remote image capturing devices to the centralized database, wherein at least a portion of the pathway is wireless; and
(iv) an interface that allows an authorized user to remotely access corresponding image data stored on the centralized database.

2. The system of claim 1, wherein said data fields comprise a data field indicative of the location at which a corresponding remote image capturing device is deployed.

3. The system of claim 2, wherein at least a portion of the pathway occurs via electronic mail.

4. The system of claim 1, wherein said data fields comprise a data field indicative of a class associated with a corresponding image.

5. The system of claim 1, wherein said data fields comprise a data field indicative of a weather characteristic associated with a corresponding image.

6. The system of claim 1, wherein said data fields comprise a data field indicative of remote image acquisition device settings associated with a capture of a corresponding image.

7. The system of claim 1, wherein said data fields comprise a data field indicative of a name assigned by a client that is associated with a corresponding remote image acquisition device.

8. The system of claim 1, wherein said data fields comprise a data field indicative of a class associated with a corresponding remote image acquisition device and a data field indicative of a class associated with a corresponding captured image.

9. The system of claim 1, wherein the communication pathway comprises a cellular network.

10. A method of providing a database of multiple images for a plurality of users, comprising the steps of:
(i) setting up a centralized database comprising image data, client data, and device data, wherein the data is associated with data fields;
(ii) providing an interface for a plurality of users to remotely access the database;
(iii) providing a plurality of image acquisition devices that are associated with the database and that a user can deploy at a remote site as desired by the user;
(iv) causing a deployed, remote image acquisition device to be linked to a user in the database;
(v) allowing the users to transmit captured images and associated data from the deployed, remote image acquisition devices to the centralized database, wherein at least a portion of the transmitting occurs wirelessly; and
(vi) allowing the users to controllably access the centralized database and view the captured images and the associated data.

11. A method of storing a remotely captured image on a centralized database, comprising the steps of:
(i) wirelessly transmitting the captured image and associated image data from a remote location to a cellular service provider; and
(ii) transmitting the captured image and associated image data from the cellular service provider to a centralized database via electronic mail; and
(iii) storing the captured image and associated image data on the centralized database.

12. A method of storing a remotely captured image on a centralized database, comprising the steps of:
(i) digitally storing an image in a multiuser database wherein access to the image is controlled; and
(ii) associating the stored image with a unique image code, a unique device code associated with a device used to capture the image, and a user code associated with a user that is authorized to have access to the stored image, wherein the image code, device code, and user code or stored in the database.

13. A method of using a remotely positioned image acquisition device to automatically capture images, comprising the steps of:
(i) upon detecting a triggering event, causing the device to capture an image;
(ii) in association with capturing the image, disallowing the device to capture additional images for a period of time; and
(iii) after the period of time has lapsed, allowing the device to capture an additional image upon detection of a triggering event.
